(19) United States
(12) Patent Application Publication
(10) Pub. No.: US 2022/0335277 A1
(43) Pub. Date: Oct. 20, 2022

(54) Deformable Fractional Filters

(71) Applicant: Intel Corporation, Santa Clara, CA (US)

(72) Inventors: Julio Cesar Zamora Esquivel, West Sacramento, CA (US); Anthony Rhodes, Portland, OR (US); Lama Nachman, Santa Clara, CA (US); Edgar Macías García, Zapopan (MX)

(21) Appl. No.: 17/856,227

(22) Filed: Jul. 1, 2022

(51) Int. Cl. G06N 3/04

(52) U.S. Cl. CPC G06N 3/0481

(57) ABSTRACT

Systems, apparatuses and methods may provide for technology that selects a fractional derivative value, determines a derivative operation based on the fractional derivative value, applies the derivative operation to an activation function to obtain a deformable fractional filter, generates a mask based on the deformable fractional filter, and convolves the mask with input data.

### TECHNICAL FIELD

Embodiments generally relate to neural networks. More particularly, embodiments relate to the use of deformable fractional filters in convolutional neural networks.

### BACKGROUND OF THE DISCLOSURE

Traditional convolutional neural networks (CNNs) typically use a fixed geometric structure in their respective building modules. Accordingly, the filters of a conventional CNN follow a rigid geometric structure that produces limited modeling. The introduction of deformable convolutions may enhance the transformation modeling capability of CNNs, but additional training parameters are typically introduced to the model, primarily because each parameter in the filter requires an additional offset (e.g., dx,dy), which multiplies by three the amount of memory required per filter.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of derivatives of a swish activation function according to an embodiment;

FIG. 2 is an illustration of an example of different sized filter components according to an embodiment;

FIG. 3 is an illustration of an example of an outer product of two one-dimensional (1D) filters according to an embodiment;

FIG. 4 is an illustration of an example of a dynamic filtering progression according to an embodiment;

FIG. 5 is an illustration of an example of an approximation of a pre-trained filter according to an embodiment;

FIG. 6 is a comparative illustration of an example of an image generated by a CNN kernel and an image generated by a fractional filter according to an embodiment;

FIG. 7 is an illustration of an example of a deformable convolution from an input feature map to an output feature map according to an embodiment;

FIG. 8 is a group of plots of an example of training error, validation error and validation accuracy for a swish fractional filter according to an embodiment;

FIG. 9 is a comparative illustration of an example of different neural network topologies according to an embodiment;

FIG. 10 is a group of plots of an example of training error, validation error and validation accuracy for a deformable fractional filter according to another embodiment;

FIG. 11 is a group of plots of an example of validation error and validation accuracy for clothing classification according to another embodiment;

FIG. 12 is an illustration of a comparative example of conventional indoor segmentation performance and indoor segmentation performance according to an embodiment;

FIG. 13 is a group of plots of a comparative example of conventional medical segmentation error and medical segmentation error according to an embodiment;

FIG. 14 is an illustration of a comparative example of conventional medical segmentation performance and medical segmentation performance according to an embodiment;

FIG. 15 is a group of plots of a comparative example of conventional hand segmentation error and hand segmentation error according to an embodiment;

FIG. 16 is an illustration of a comparative example of conventional hand segmentation performance and hand segmentation performance according to an embodiment;

FIG. 17 is a flowchart of an example of a method of operating a performance-enhanced computing system according to an embodiment;

FIG. 18 is a block diagram of an example of a performance-enhanced computing system according to an embodiment;

FIG. 19 is an illustration of an example of a semiconductor package apparatus according to an embodiment;

FIG. 20 is a block diagram of an example of a processor according to an embodiment; and

FIG. 21 is a block diagram of an example of a multi-processor based computing system according to an embodiment.

### DETAILED DESCRIPTION

Technology described herein replaces deformable filter kernels with “deformable fractional filters” that require only three trainable parameters. Accordingly, a CNN using the technology described here requires 1.8×, 5× or 9.8× less memory than 3×3, 5×5 and 7×7 kernel sizes, respectively.

More particularly, embodiments replace traditional convolutional filters in deformable convolutional filters for CNNs with generalized “fractional filters” (see, Equations (1) and (4)). The proposed fractional filters are based on fractional derivatives from fractional calculus. The proposed “deformable fractional filters” can replace traditional filters because the deformable fractional filters can approximate swish filters and/or activation functions, “Sobel” (e.g., Derivative of Gaussian (DoG)), “Laplacian of Gaussian (LoG)” filters. Moreover, a deformable fractional filter can also generate filters not previously defined that can be imagined as intermediate steps between each of the filters mentioned. The proposed deformable fractional filter is defined using only three dynamic parameters (see, Equations (1) and (4)), which reduces training time and memory requirements relative to typical filters.

The technology described herein enables Memory reduction for CNNs—Applied to machine learning, embodiments can enable the creation of deformable convolutional layers with parametric filters, instead of adjusting every mask parameter. Accordingly, the memory needed in an n×n kernel inside of the deformable filter reduces by n²/3 times.

The technology described herein also enables less adjustable parameters. The adjustment of every parameter considers the complete filter, yielding in only three training rules for the multiplied weights.

Additionally, the technology described herein provides a better handling of random initialization. Based on the nature of the parameter in the filter, every parameter could have its own range of values for initialization.

Moreover, the technology described herein enable subpixel training—Since the filter is not a set of discrete values, the filter can be applied in a subpixel-based training approach. In addition, the mapping to the frequency domain is analytical instead of numerical.

A deformable fractional filter is composed by a swish based fractional filter and the offsets per filter component. The generation of the filter components based on the fractional derivative of the swish function may be detailed as follows.

Embodiments use the concept of fractional derivatives from fractional calculus theory to generate an infinite number of filters that can be seen to lie in between as interpolating swish filters by defining a “fractional filter” as:

$${D}^{a} G = \frac{1}{{h}^{a}} {\sum }_{n = 0}^{\text{?}} {( - 1 )}^{n} \frac{Γ ( a + 1 )}{Γ ( n + 1 ) Γ ( 1 - n + a )} ( x - nh ) σ ( x - nh ) \qquad ( 1 )$$

$$\text{?} \text{indicates text missing or illegible when filed}$$

Where G=xσ(x) is the swish, “a” is the fractional derivative order and Γ(α) represents the gamma function, defined as:

Γ(z)=∫₀^{∞}t^{(z-1)}e^{-t}dt (2)

Computationally, it is possible to approximate this Gamma function by taking 300 iterations as a multiplicator operation:

$$Γ ( x ) = \frac{{e}^{- 0.57 x}}{x} {{Π}_{k = 1}}^{300} ( {( 1 + \frac{x}{k} )}^{- 1} {e}^{\text{?}} ) \qquad ( 3 )$$

$$\text{?} \text{indicates text missing or illegible when filed}$$

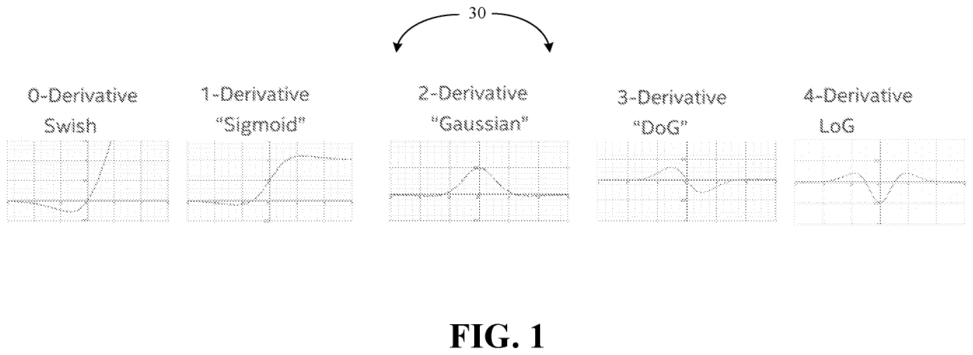

FIG. 1 shows that a fractional filter enables a single general filter to be used for different applications. By changing a single trainable parameter (the order of the fractional derivative) it is possible to generate different shapes of filters 30.

In particular, for 2D the following definition of the fractional filter may be introduced:

F=D^{α}G(x)=D^{α}xσ(x) (4)

In order to reduce the complexity of Equation (1) a new recursive method is used to compute the fractional derivatives:

g₁(x)=xw(x)

g₂(x)=g₁(x)+k₁)(1−g₁(x))

g₃(x)=g₂(x)−k₂(1−2g₂(x))

g₄(x)=g₃(x)−k₃(1−g₂(x)−3g₃(x))

g₅(x)=g₄(x)−k₄(1−g₂(x)−3g₃(x)−4g₄(x))

g₆(x)=g₅(x)−k₅(1−g₂(x)−4g₃(x)−6g₄(x)−6g₅(x))

Where gᵢ represents the (i−1) derivative and the coefficients kᵢ interpolate linearly the order of the derivation in a fractional range.

k₁=(R(α)−R(α−1))w(x)

k₂=(R(α−1)−R(α−2))w(x)

k₃=(R(α−2)−R(α−3))w(x)

k₄=(R(α−3)−R(α−4))w(x)

k₅=(R(α−4)−R(α−5))w(x)

Where “a” represents the order of the derivative and the final output is G(x)=g₆(x).

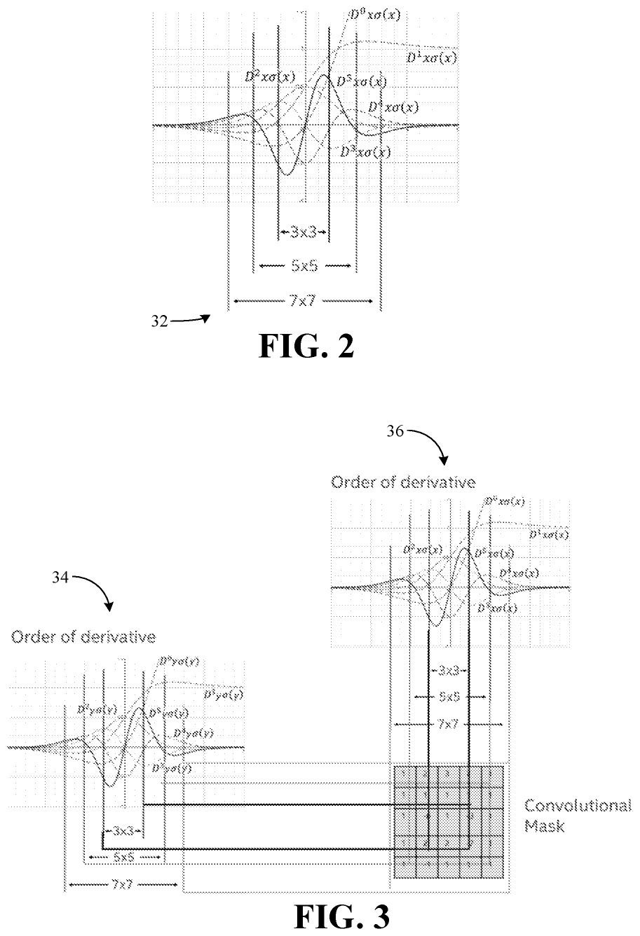

As shown in FIG. 2, this function creates a one-dimensional function depending on the parameter “a”, wherein the coefficients of the filter are being generated to evaluate the function for the spatial location of the filter. Thus, the size 32 of the filter does not increase the number of parameters. It is also possible to train a filter and during the inference, pick the size 32 depending on the computational resources available.

Turning now to FIG. 3, the two-dimensional filters can be generated by an outer product of two one-dimensional filters 34, 36. In the illustrated example, “a” is the fractional derivative on the x-dimension and “b” is the fractional derivative on the y-dimension.

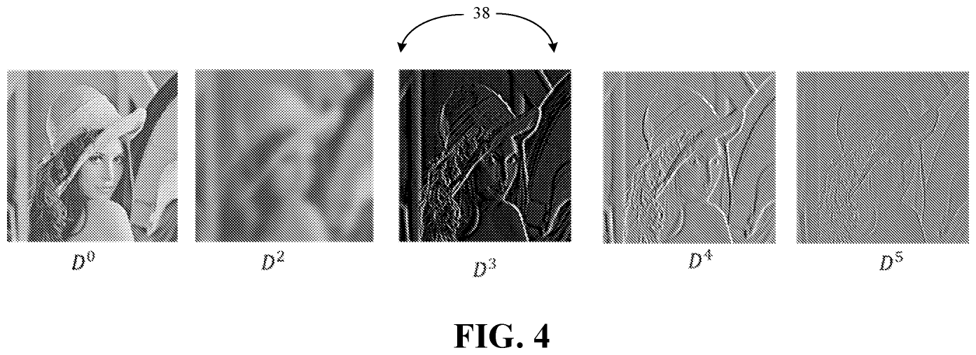

FIG. 4 shows a dynamic filtering progression 38 in which the fractional order of derivation is changed between the range of a=(0,5). This evaluation was performed by computing a 5×5 mask as result of the evaluation of D^{a}G, and convolving with the input image, where “a” is the derivative order value.

In an embodiment, a fractional swish filter is a constrained filter because the parameters of the filter are not independent as in the traditional convolutional filters used in CNN. The fractional swish filter can, however, start approximating pre-trained filters and then fine tune to convert to the fractional filter.

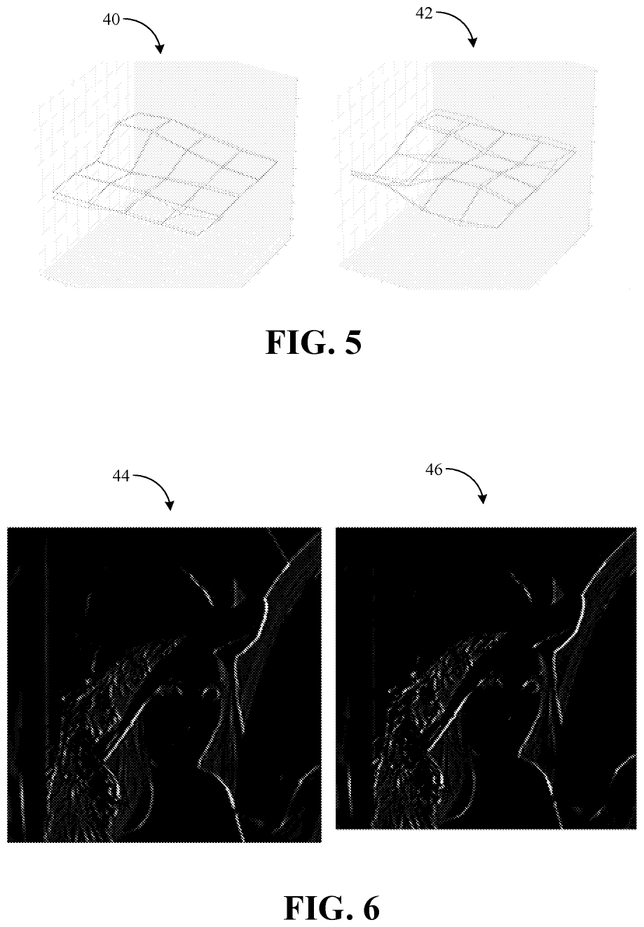

For example, FIGS. 5 and 6 demonstrate that for a single 5×≡filter 40, similar filters 42 can be generated to approximate the original 5×≡filter 40. The result is a similar effect over the output images in which the fractional swish filters can replace the original ones. Thus, an image 44 generated by a fractional filter is similar to an image 46 generated by a CNN kernel.

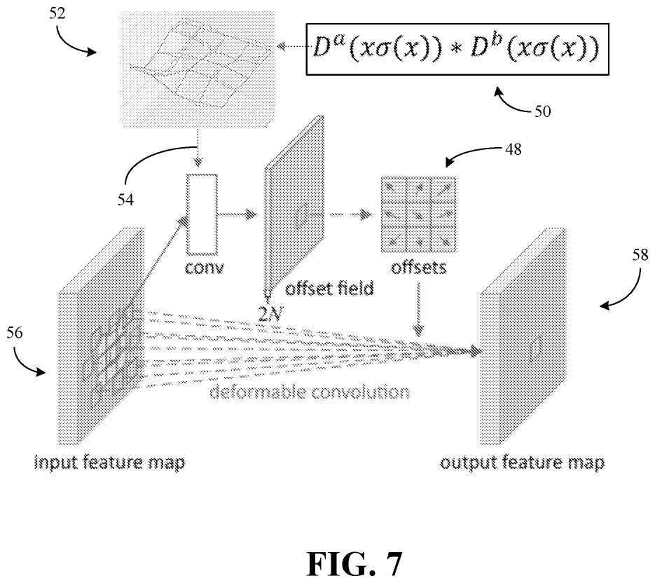

FIG. 7 demonstrates that a deformable fractional has a block 48 for offsets and another block 50 to generate the filter coefficients based in the order of the derivative. Thus, one or more fractional derivative values (e.g., “a” and “b”) are selected, wherein the block 50 determines a derivative operation based on the fractional derivative value(s) and applies the derivative operation(s) to an activation function to obtain a deformable fractional filter 52. A mask 54 may then be generated based on the deformable fractional filter 52, wherein the mask 54 is convolved with input data 56 (e.g., input feature map) to obtain an output feature map 58.

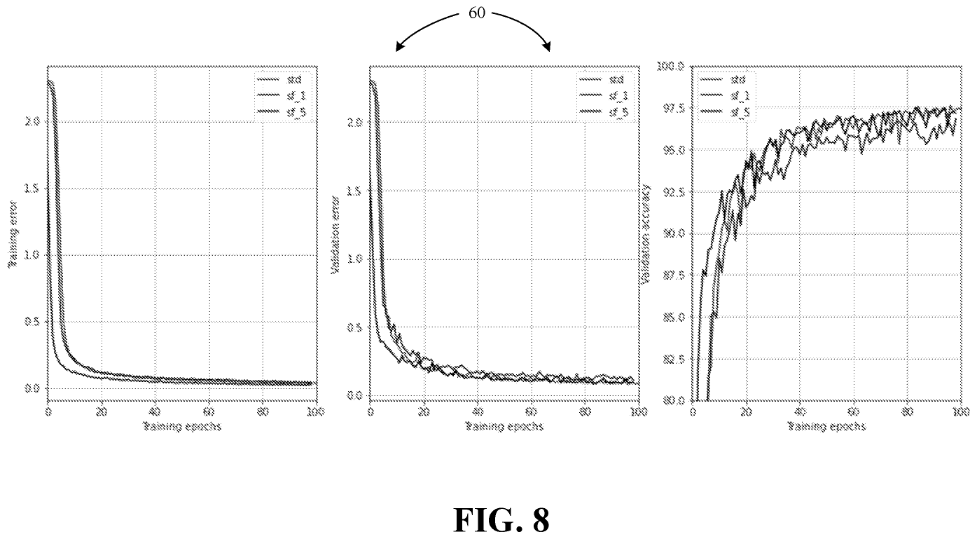

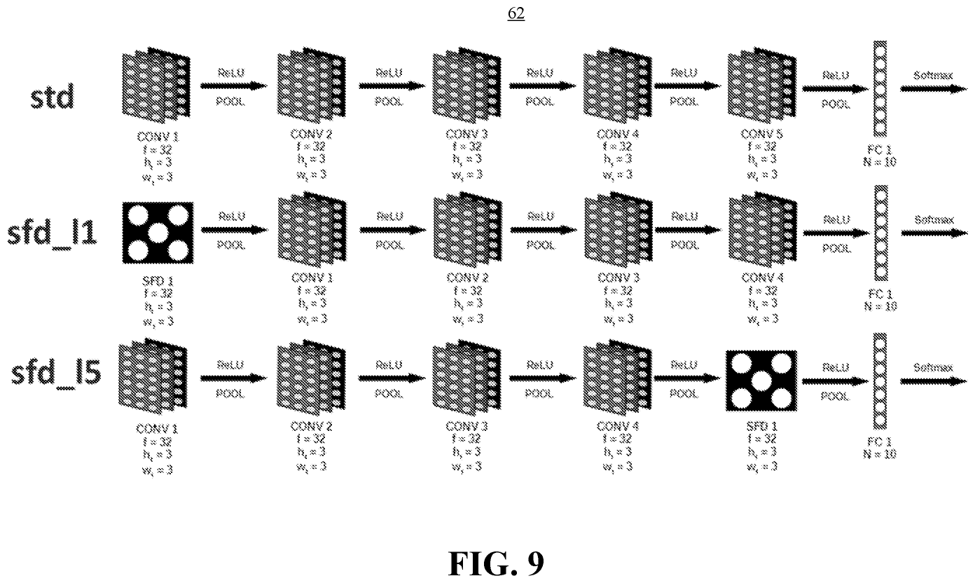

FIGS. 8 and 9 show a group of plots 60 resulting from a set of experiments on a Modified National Institute of Standards and Technology (MNIST) dataset in which only a swish fractional (“sf”) filter was evaluated for neural network topologies 62 (e.g., replacing the first and fifth layers in a standard filter (“std”) with the swish fractional filter). The plots show training error, validation error and accuracy. Here, for instance, the layer five topology generates similar accuracy while using 6000 less parameters. Moreover, the training is faster.

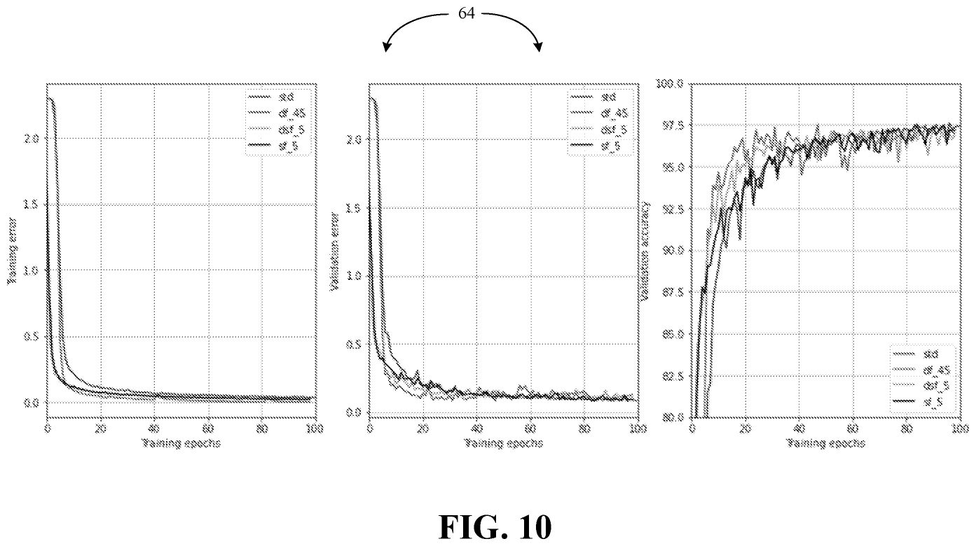

FIG. 10 shows a group of plots 64 comparing the deformable fractional (“df”) filter to a standard filter, a deformable swish filter (“dsf”) and a swish filter. In the illustrated example, the deformable fractional filter has the same accuracy at the end, while converging faster and with fewer parameters.

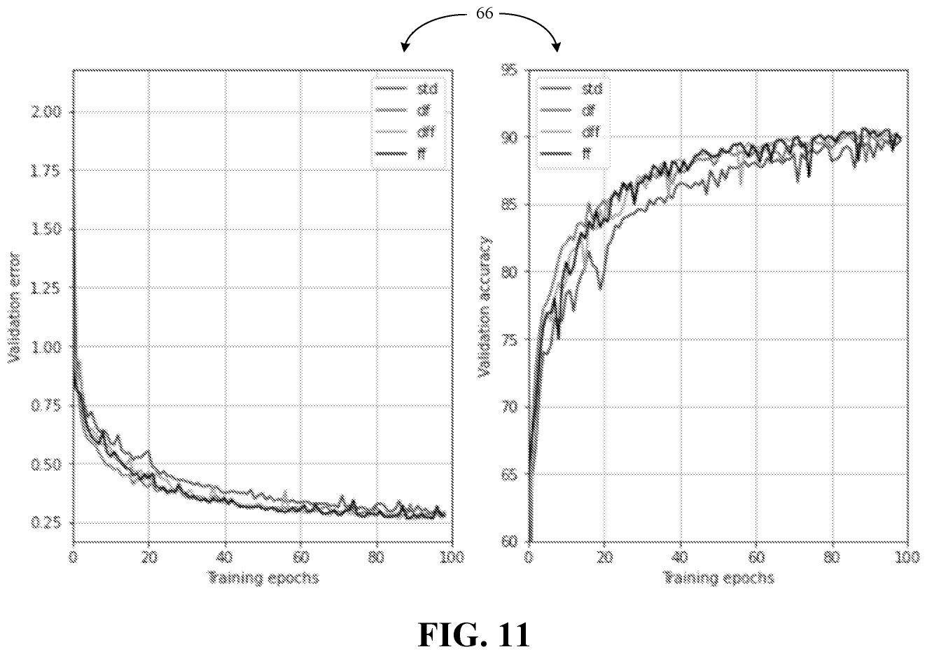

FIG. 11 shows a group of plots 66 resulting from a set of experiments on a Fashion-MNIST dataset (e.g., clothing classification) in which the same behavior presented for the MNIST dataset is achieved for the different employed models. The deformable fractional model achieves an intermediate performance between deformable and fractional filters, by preserving the accuracy while reducing the number of model parameters. Thus, the deformable fractional filter produces a compression of 10,000 parameters, while maintaining accuracy, as shown in Table I.

TABLE I

| Model | Parameters | Model | Parameters |
|---|---|---|---|
| 5-CNN model | 37912 | DF model | 53248 |
| FF model | 31466 | DFF model | 40613 |

Semantic Segmentation

Considering the task of indoor semantic segmentation, the dilated ResNet50 model was employed over the ADE20K dataset. In this implementation, the last convolution of the decoder block was replaced with a deformable fractional filter and trained over thirty epochs.

TABLE II

| Model (Encoder + Decoder) | Parameters | Accuracy |
|---|---|---|
| MobileNetV2dilated + C1 | 218932 | 76.8 |
| MobileNetV2dilated + PPM | 13588396 | 78.26 |
| ResNet18dilated + C1 | 12248940 | 77.41 |
| ResNet18dilated + PPM | 24566636 | 79.29 |
| ResNet50dilated + PPM | 51579116 | 80.13 |
| UpperNet50 | 64222294 | 80.23 |
| DFF-ResNet50Dilated + PPM | 39106871 | 80.27 |
| ResNet101dilated + PPM | 70571244 | 80.91 |

Once trained, the modified model (“DFF-ResNet50Dilated+PPM”) achieves a general accuracy of 80.27% on the validation dataset. As presented in Table II, the model with a deformable fractional filter was able to preserve the same generalization capacity than the standard model while employing fewer trainable parameters (e.g., around 24% fewer parameters). Indeed, the modified model, even surpassed the performance of larger models (e.g., ResNet 50).

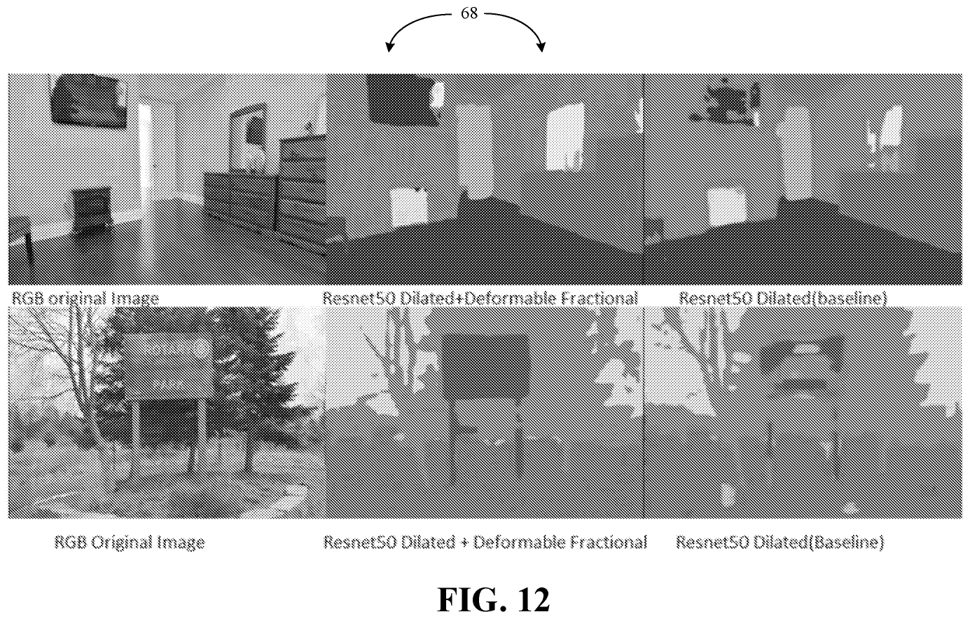

Turning now to FIG. 12, the modified model was compared with the standard model to segment the frames of a random video as an additional evaluation to differentiate the qualitative performance of the filters. A group of images 68 demonstrates that the model with the deformable fractional filters achieves smoother segmentation frames compared with the standard network architecture employing a small number of model parameters.

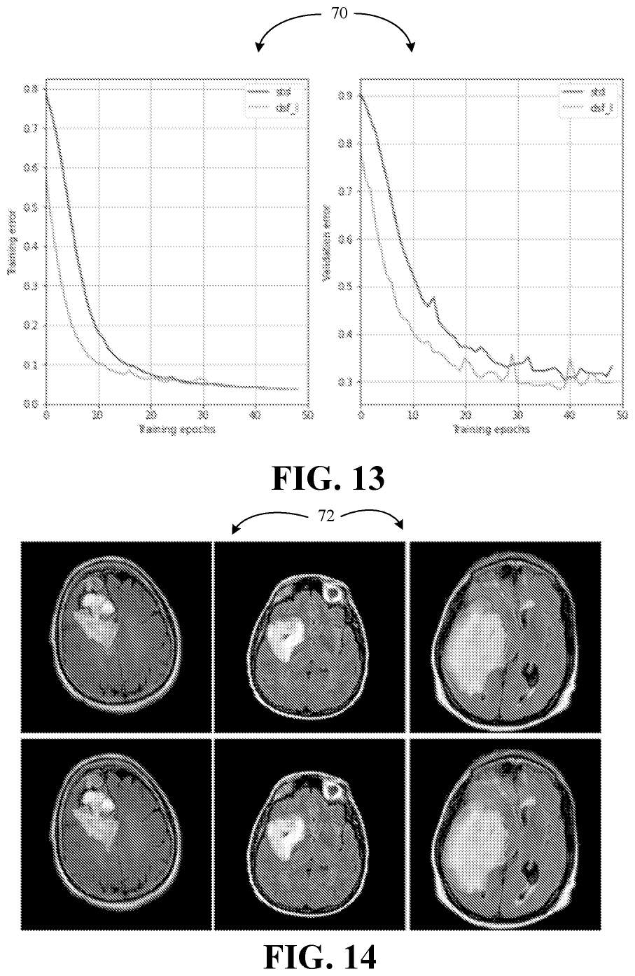

Turning now to FIGS. 13 and 14, medical image segmentation (e.g., anomaly segmentation) was conducted by employing the U-Net CNN architecture a subset of the The Cancer Genome Atlas Low Grade Glioma (TCGA-LGG) dataset. In this implementation, the last convolutional layer of the network was replaced by a deformable fractional filter with a 3×3 kernel. Then, the standard and modified models were trained and evaluated through 50 epochs using the same hyperparameters over the dataset. A group of plots 70 demonstrates that the model with the deformable fractional filter achieves better convergence speed in both training and validation datasets. A group of images 72 shows that good segmentation results were achieved still at the first epoch and similar final dice similarity coefficient (DSC) score (e.g., 91.113% for the modified, and 91.03% for the standard model, respectively).

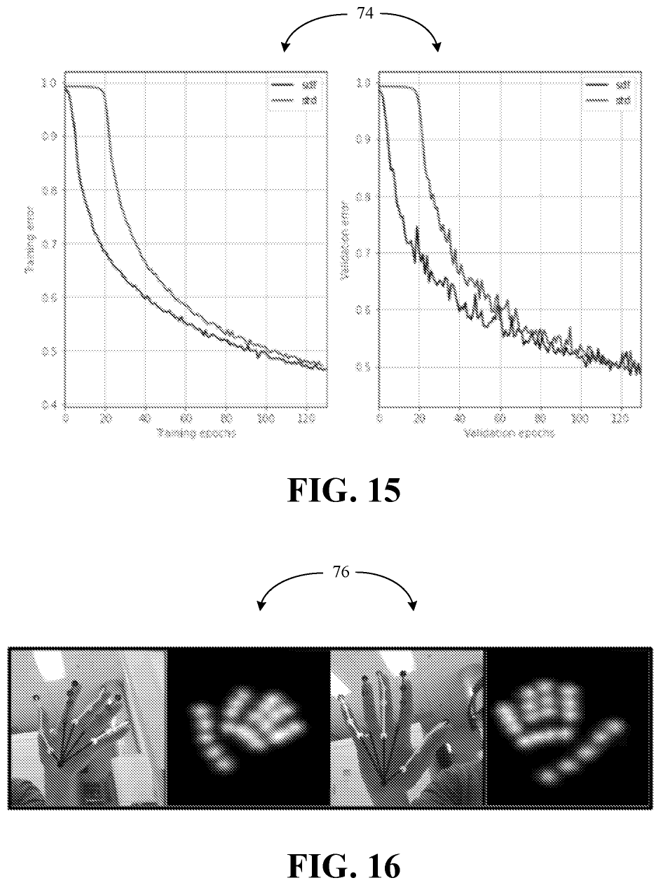

FIGS. 15 and 16 demonstrate results from employing a shallow U-Net CNN architecture on a FreiHAND dataset (e.g., provided in “2D hand-repo”). As in previous examples, a standard model was compared with a modified version by replacing the last convolutional layer with a deformable fractional filter using the same hyperparameters. A group of plots 74 demonstrates that the same fast-convergence performance is achieved when employing deformable fractional filters compared to standard filter. Additionally, a group of image 76 shows fingers from both hands being detected in real-time using a CNN running on a WINDOWS Universal platform. The left images are segmented with the finger positions and the right images show the output produced by the neural network.

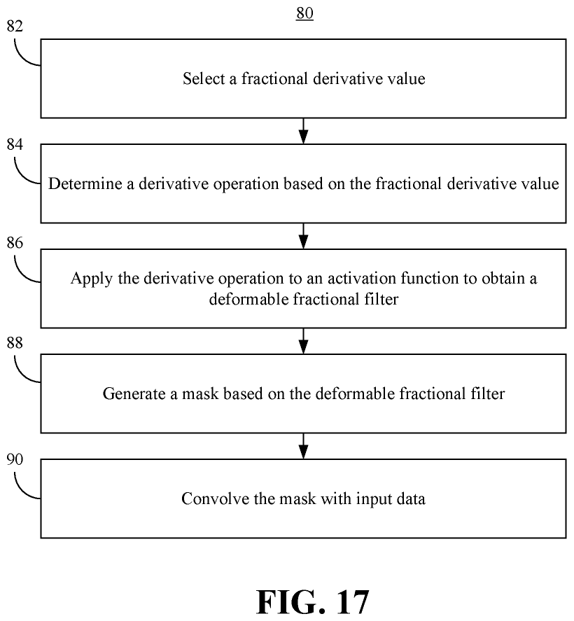

FIG. 17 shows a method 80 of operating a performance-enhanced computing system. The method 80 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 80 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 82 selects a fractional derivative value. In an embodiment, block 82 includes recursively computing the fractional derivative value to reduce the complexity of Equation (1). Block 84 determines a derivative operation based on the fractional derivative value, wherein block 86 applies the derivative operation to an activation function to obtain a deformable fractional filter. In one example, block 86 includes approximating a gamma function. Additionally, the activation function may be a swish function. In an embodiment, the deformable fractional filter is a 2D filter. In such a case, block 86 may involve determining an outer product of two 1D filters.

Block 88 provides for generating a mask based on the deformable fractional filter. In one example, block 88 includes selecting a size of the mask based on computational resource availability. Additionally, block 90 convolves the mask with input data (e.g., to obtain an output feature set).

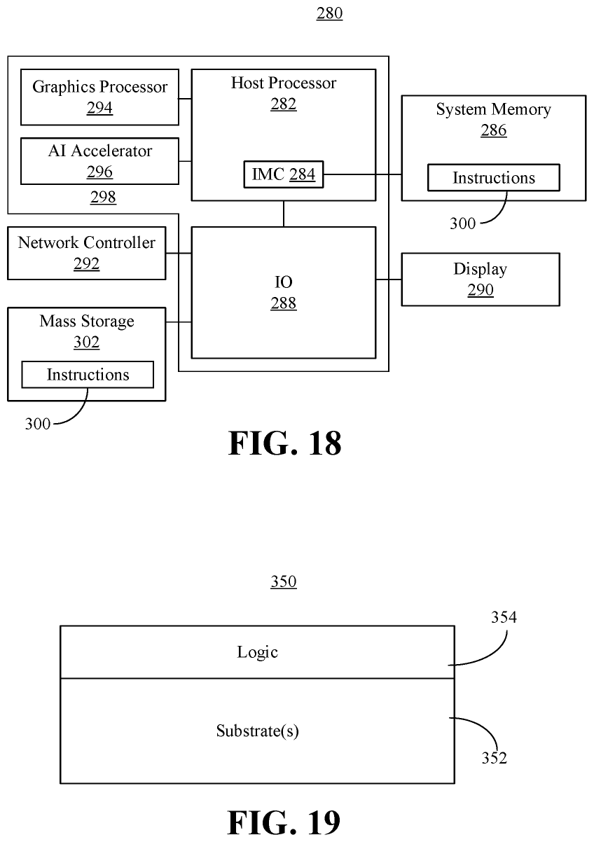

Turning now to FIG. 18, a performance-enhanced computing system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof

In the illustrated example, the system 280 includes a host processor 282 (e.g., CPU) having an integrated memory controller (IMC) 284 that is coupled to a system memory 286 (e.g., dual inline memory module/DIMM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 into a system on chip (SoC) 298.

In an embodiment, the host processor 282 and/or the AI accelerator 296 executes a set of program instructions 300 retrieved from the mass storage 302 and/or the system memory 286 to perform one or more aspects of the method 80 (FIG. 17), already discussed. Thus, execution of the illustrated instructions 300 by the host processor 282 and/or the AI accelerator 296 causes the host processor 282 and/or the AI accelerator 296 to select a fractional derivative value, determine a derivative operation based on the fractional derivative value, apply the derivative operation to an activation to obtain a deformable fractional filter, generate a mask based on the deformable fractional filter, and convolve the mask with the input data.

FIG. 19 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 80 (FIG. 17).

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

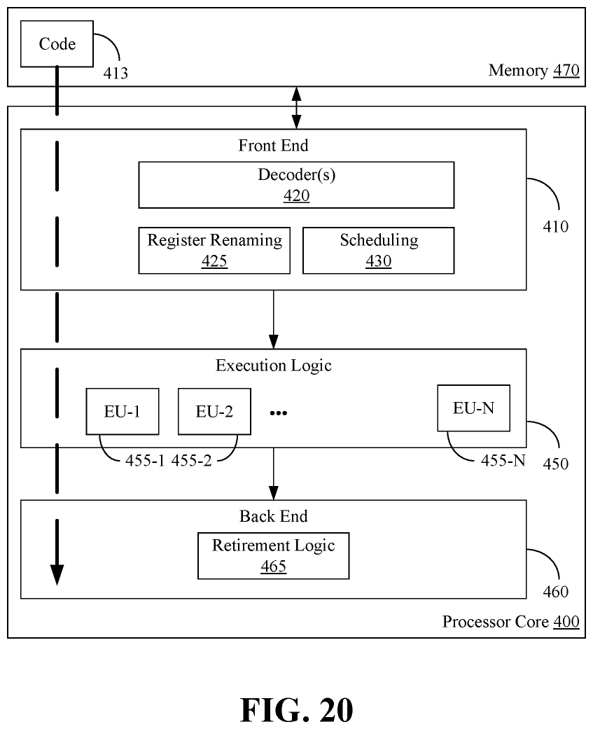

FIG. 20 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 20, a processing element may alternatively include more than one of the processor core 400 illustrated in FIG. 20. The processor core 400 may be a single-threaded core or, for at least one embodiment, the processor core 400 may be multithreaded in that it may include more than one hardware thread context (or “logical processor”) per core.

FIG. 20 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 80 (FIG. 17), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 20, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

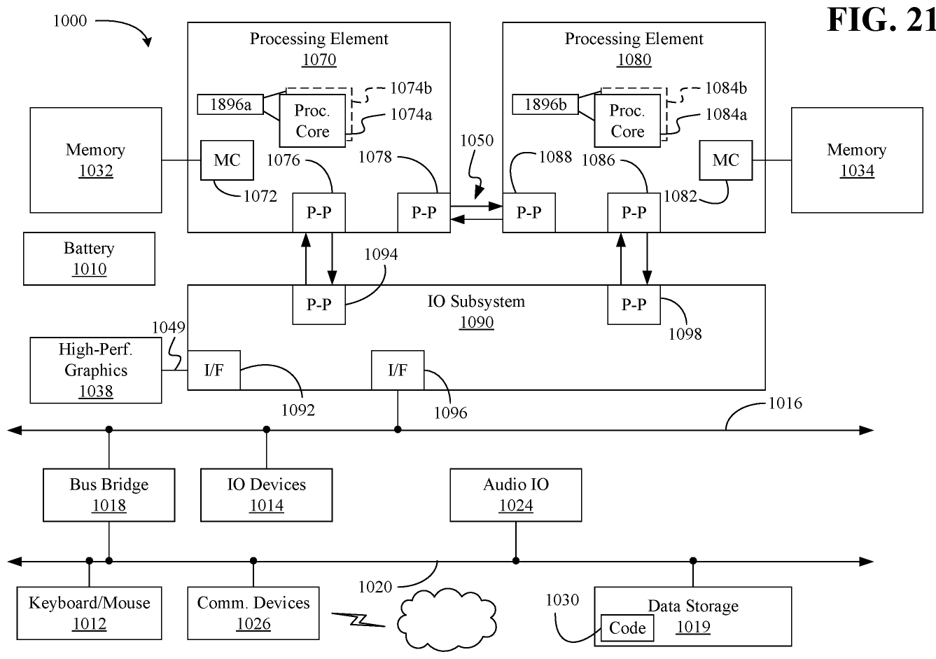

Referring now to FIG. 21, shown is a block diagram of a computing system 1000 embodiment in accordance with an embodiment. Shown in FIG. 21 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 21 may be implemented as a multi-drop bus rather than point-to-point interconnect.

As shown in FIG. 21, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 20.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 21, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 21, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 21, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 80 (FIG. 17), already discussed. Further, an audio I/O 1024 may be coupled to second bus 1020 and a battery 1010 may supply power to the computing system 1000.

Note that other embodiments are contemplated. For example, instead of the point-to-point architecture of FIG. 21, a system may implement a multi-drop bus or another such communication topology. Also, the elements of FIG. 21 may alternatively be partitioned using more or fewer integrated chips than shown in FIG. 21.

### ADDITIONAL NOTES AND EXAMPLES

Example 1 includes a performance-enhanced computing system comprising a network controller, a processor coupled to the network controller, and a memory coupled to the processor, the memory including a set of instructions, which when executed by the processor, cause the processor to select a fractional derivative value, determine a derivative operation based on the fractional derivative value, apply the derivative operation to an activation function to obtain a deformable fractional filter, generate a mask based on the deformable fractional filter, and convolve the mask with input data.

Example 2 includes the computing system of Example 1, wherein to apply the derivative operation to the activation function, the instructions, when executed, cause the processor to approximate a gamma function.

Example 3 includes the computing system of Example 1, wherein the activation function is to be a swish function.

Example 4 includes the computing system of Example 1, wherein the deformable fractional filter is to be a two-dimensional (2D) filter, and wherein to apply the derivative operation to the activation function, the instructions, when executed, cause the processor to determine an outer product of two one-dimensional (1D) filters.

Example 5 includes the computing system of Example 1, wherein to select the fractional derivative value, the instructions, when executed, cause the processor to recursively compute the fractional derivative value.

Example 6 includes the computing system of any one of Examples 1 to 5, wherein the instructions, when executed, further cause the processor to select a size of the mask based on computational resource availability.

Example 7 includes at least one computer readable storage medium comprising a set of instructions, which when executed by a computing system, cause the computing system to select a fractional derivative value, determine a derivative operation based on the fractional derivative value, apply the derivative operation to an activation function to obtain a deformable fractional filter, generate a mask based on the deformable fractional filter, and convolve the mask with input data.

Example 8 includes the at least one computer readable storage medium of Example 7, wherein to apply the derivative operation to the activation function, the instructions, when executed, cause the computing system to approximate a gamma function.

Example 9 includes the at least one computer readable storage medium of Example 7, wherein the activation function is to be a swish function.

Example 10 includes the at least one computer readable storage medium of Example 7, wherein the deformable fractional filter is to be a two-dimensional (2D) filter, and wherein to apply the derivative operation to the activation function, the instructions, when executed, cause the computing system to determine an outer product of two one-dimensional (1D) filters.

Example 11 includes the at least one computer readable storage medium of Example 7, wherein to select the fractional derivative value, the instructions, when executed, cause the computing system to recursively compute the fractional derivative value.

Example 12 includes the at least one computer readable storage medium of any one of Examples 7 to 11, wherein the instructions, when executed, further cause the computing system to select a size of the mask based on computational resource availability.

Example 13 includes a semiconductor apparatus comprising one or more substrates, and logic coupled to the one or more substrates, wherein the logic is implemented at least partly in one or more of configurable or fixed-functionality hardware, the logic to select a fractional derivative value, determine a derivative operation based on the fractional derivative value, apply the derivative operation to an activation function to obtain a deformable fractional filter, generate a mask based on the deformable fractional filter, and convolve the mask with input data.

Example 14 includes the semiconductor apparatus of Example 13, wherein to apply the derivative operation to the activation function, the logic is to approximate a gamma function.

Example 15 includes the semiconductor apparatus of Example 13, wherein the activation function is to be a swish function.

Example 16 includes the semiconductor apparatus of Example 13, wherein the deformable fractional filter is to be a two-dimensional (2D) filter, and wherein to apply the derivative operation to the activation function, the logic is to determine an outer product of two one-dimensional (1D) filters.

Example 17 includes the semiconductor apparatus of Example 13, wherein to select the fractional derivative value, the logic is to recursively compute the fractional derivative value.

Example 18 includes the semiconductor apparatus of any one of Examples 13 to 17, wherein the logic is further to select a size of the mask based on computational resource availability.

Example 19 includes the semiconductor apparatus of any one of Examples 13 to 18, wherein the logic coupled to the one or more substrates includes transistor channel regions that are positioned within the one or more substrates.

Example 20 includes a method of operating a performance-enhanced computing system, the method comprising selecting a fractional derivative value, determining a derivative operation based on the fractional derivative value, applying the derivative operation to an activation function to obtain a deformable fractional filter, generating a mask based on the deformable fractional filter, and convolving the mask with input data.

Example 21 includes the method of Example 20, wherein applying the derivative operation to the activation function includes approximating a gamma function.

Example 22 includes the method of Example 20, wherein the activation function is a swish function.

Example 23 includes the method of Example 20, wherein the deformable fractional filter is a two-dimensional (2D) filter, and wherein applying the derivative operation to the activation function includes determining an outer product of two one-dimensional (1D) filters.

Example 24 includes the method of Example 20, wherein selecting the fractional derivative value includes recursively computing the fractional derivative value.

Example 25 includes the method of any one of Examples 20 to 24, further including selecting a size of the mask based on computational resource availability.

Example 26 includes an apparatus comprising means for performing the method of any one of Examples 20 to 25.

Thus, technology described herein generalizes typical deformable filters and implements the filters using only one general function, defined as a parametric model. The technology described herein produces an infinite number of possible filters, replacing traditional trainable deformable convolutional kernels. Applied to machine learning, this approach enables the creation of convolutional layers with parametric filters, replacing the adjustment of every mask parameter, thus reducing by n²/3 times the memory used via n×n kernels.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a set of instructions, which when executed by the processor, cause the processor to:
select a fractional derivative value,
determine a derivative operation based on the fractional derivative value,
apply the derivative operation to an activation function to obtain a deformable fractional filter,
generate a mask based on the deformable fractional filter, and
convolve the mask with input data.

2. The computing system of claim 1, wherein to apply the derivative operation to the activation function, the instructions, when executed, cause the processor to approximate a gamma function.

3. The computing system of claim 1, wherein the activation function is to be a swish function.

4. The computing system of claim 1, wherein the deformable fractional filter is to be a two-dimensional (2D) filter, and wherein to apply the derivative operation to the activation function, the instructions, when executed, cause the processor to determine an outer product of two one-dimensional (1D) filters.

5. The computing system of claim 1, wherein to select the fractional derivative value, the instructions, when executed, cause the processor to recursively compute the fractional derivative value.

6. The computing system of claim 1, wherein the instructions, when executed, further cause the processor to select a size of the mask based on computational resource availability.

7. At least one computer readable storage medium comprising a set of instructions, which when executed by a computing system, cause the computing system to:
select a fractional derivative value;
determine a derivative operation based on the fractional derivative value;
apply the derivative operation to an activation function to obtain a deformable fractional filter;
generate a mask based on the deformable fractional filter; and
convolve the mask with input data.

8. The at least one computer readable storage medium of claim 7, wherein to apply the derivative operation to the activation function, the instructions, when executed, cause the computing system to approximate a gamma function.

9. The at least one computer readable storage medium of claim 7, wherein the activation function is to be a swish function.

10. The at least one computer readable storage medium of claim 7, wherein the deformable fractional filter is to be a two-dimensional (2D) filter, and wherein to apply the derivative operation to the activation function, the instructions, when executed, cause the computing system to determine an outer product of two one-dimensional (1D) filters.

11. The at least one computer readable storage medium of claim 7, wherein to select the fractional derivative value, the instructions, when executed, cause the computing system to recursively compute the fractional derivative value.

12. The at least one computer readable storage medium of claim 7, wherein the instructions, when executed, further cause the computing system to select a size of the mask based on computational resource availability.

13. An apparatus comprising:
one or more substrates; and
logic coupled to the one or more substrates, wherein the logic is implemented at least partly in one or more of configurable or fixed-functionality hardware, the logic to:
select a fractional derivative value;
determine a derivative operation based on the fractional derivative value;
apply the derivative operation to an activation function to obtain a deformable fractional filter;
generate a mask based on the deformable fractional filter; and
convolve the mask with input data.

14. The apparatus of claim 13, wherein to apply the derivative operation to the activation function, the logic is to approximate a gamma function.

15. The apparatus of claim 13, wherein the activation function is to be a swish function.

16. The apparatus of claim 13, wherein the deformable fractional filter is to be a two-dimensional (2D) filter, and wherein to apply the derivative operation to the activation function, the logic is to determine an outer product of two one-dimensional (1D) filters.

17. The apparatus of claim 13, wherein to select the fractional derivative value, the logic is to recursively compute the fractional derivative value.

18. The apparatus of claim 13, wherein the logic is further to select a size of the mask based on computational resource availability.

19. The apparatus of claim 13, wherein the logic coupled to the one or more substrates includes transistor channel regions that are positioned within the one or more substrates.

20. A method comprising:
selecting a fractional derivative value;
determining a derivative operation based on the fractional derivative value;
applying the derivative operation to an activation function to obtain a deformable fractional filter;
generating a mask based on the deformable fractional filter; and
convolving the mask with input data.

21. The method of claim 20, wherein applying the derivative operation to the activation function includes approximating a gamma function.

22. The method of claim 20, wherein the activation function is a swish function.

23. The method of claim 20, wherein the deformable fractional filter is a two-dimensional (2D) filter, and wherein applying the derivative operation to the activation function includes determining an outer product of two one-dimensional (1D) filters.

24. The method of claim 20, wherein selecting the fractional derivative value includes recursively computing the fractional derivative value.

25. The method of claim 20, further including selecting a size of the mask based on computational resource availability.
